(19) United States
(12) Patent Application Publication
(10) Pub. No.: US 2006/0208495 A1
(43) Pub. Date: Sep. 21, 2006

(54) Glove box latch

(76) Inventors: Robin Talukdar, Boblingen (DE); Jason Lieu, Redditch (GB); Daryl Harrigan, Coventry (GB)

Correspondence Address: PAUL AND PAUL, 2000 MARKET STREET, SUITE 2900, PHILADELPHIA, PA, 19103, US

(21) Appl. No.: 11/073,058

(22) Filed: Mar. 5, 2005

(51) Int. Cl. E05C 9/12

(52) U.S. Cl. 292/39

(57) ABSTRACT

An automotive glove box latch incorporates a two point drop pawl structure where the pawls operate in unison (in parallel) in response to the operation of an activation button or paddle, positioned away (disparate) from the pawls and at the side of the glove box. The pawls are mounted within a housing which extends across the glove box door to which the latch housing is mounted. A spring biased lock-plate operates within the housing and is connected to the activation button for movement in response thereto. A pair of step-up gears is positioned within the housing. Each is driven by the lock plate to thereby impart movement to a respective one of the pawls through an engagement with rack teeth carried on each pawl. The lock-plate implements this function with a pair of rack teeth tracks carried thereon, one rack tooth track for engaging a respective one of the step-up gears.

### BACKGROUND OF THE INVENTION

The present invention is directed to latch assembly for an automotive glove box. Latch and latch assemblies are relied upon in many applications for securing panels and doors to cabinets and enclosures. For example, closets and compartments and the like, including automotive glove boxes, may have doors and pivotal panels, which may be secured with a releasable latch.

Such latches when utilized in the automotive field, may be used to control access to various compartments, such as for example, a trunk compartment or a passenger compartment in a vehicle, as well as a glove box. In this regard, various latches for panel closures have been employed mounted to a moveable panel, such as a swinging door on an automotive glove box. Typically such glove box doors swing open downwardly, with the weight of the door exerting a force on the latch prior to opening. Safety standards for modern automobiles have caused manufacturers to position glove boxes and glove box doors lower than previously, and often at knee level, almost under the dashboard. This has caused glove box doors to support the weight of the contents of the glove box, whether latched or open.

An example of a latch is shown in U.S. Pat. No. 4,838,056, issued to L. S. Weinerman, et al. Weinerman discloses a latch and lock assembly having expansible latch elements. In another publication, Weinerman, et al., U.S. Pat. No. 4,850,208, describe a latch and lock assembly with spring-biased pivotal pivot bolts. A rotary paddle latch is shown by M. J. Rachocki, U.S. Pat. No. 4,911,487; while a paddle handle latch is shown by M. Edmonds, et al. in U.S. Pat. No. 4,989,907. K. A. Bull, in U.S. Pat. No. 5,098,141, shows a quick release glove box latch mechanism. S. J. Gleason, et al. describe a door closure assembly in U.S. Pat. No. 5,127,686. Ratchet-type latch assemblies have been shown by K. Takimoto, in U.S. Pat. No. 5,234,238.

Often times it is desirable to have a two point or double point latch mechanism. This is especially true where a compartment door, such as an automotive glove box door, includes a compartmented tray for holding items and the door opens downwardly. Applications for two point latching, however, are not limited to automotive glove box doors.

Prior latches of this type often include a gear or rack and pinion. Paulson et al. U.S. Pat. No. 4,973,091, disclose a two point latch for a patio door. Davidian, U.S. Pat. No. 5,060,991, discloses a door latch assembly including a rack and pinion. Munich, U.S. Pat. No. 5,172,944, discloses a multiple point cam-pinion door latch, while Mantarakis, U.S. Pat. No. 6,023,952, discloses a door handle with an offset lock actuator, and Rozema, U.S. Pat. No. 6,095,573, discloses a translating handle assembly.

These latches, however, are generally designed for a specific application, i.e., a specific structural design configuration. In many automotive glove box applications, these latches, typically, are positioned at the center of a glove box, juxtaposed the keeper hook or hooks, which keepers are often made of wire.

What is desired is a latch assembly, which will enable an automotive glove box latch release handle or paddle to be positioned at the side of the glove box, when the glove box door panel keeper or keepers are disparate from the handle region.

What is further desired such an off-set, latch assembly is to provide a structure which has an ease of operation for the latch release, when the latch pawls are subjected to increased pressures against them from the weight of objects stored in the glove box and laying against the glove box door panel.

What is even further desired is a latch assembly with a linking or activation mechanism with improved mechanical strength.

The objects of this invention are to provide these features in one structure, in which the component elements remain the same, but the assembly can be switched from right-hand to left-hand with a minimum of reconfiguration.

### SUMMARY OF THE INVENTION

The objectives of the present invention are achieved in a drop pawl latch, which can incorporate a single drop pawl, which operates vertically. Alternatively the latch has two drop pawls that are operated jointly, in parallel, by a single activator lock-plate, which movement thereof is in response to the operation of an activator button. The lock-plate is spring biased to the retracted position, wherein the drop pawl(s) are fully extended. Gears are used to change movement direction and the length of movement and the movement ratio of latch components with minimal frictional wear on the latch components.

A housing for the latch is mountable to a door panel and is intended to extend across the panel. The drop pawls are positioned within the housing as appropriate to extend outwardly there from and to be adjacent a respective location of a keeper with which a respective pawl engages.

A step-up gear is positioned for rotation within the housing, with a separate step-up gear being utilized for each drop pawl present. Each step-up gear has a smaller pinion gear and a larger pinion gear. Each pawl carries a track of rack teeth along a longitudinal side thereof. One of the gears of each step-up gear is engaged by the rack teeth on a respective pawl for moving that pawl.

The lock-plate is positioned for longitudinal movement within the housing, with an operator end extending outside of the housing and its retracted position being within the housing. This lock-plate, which an be implemented as a flat elongate bar, carries a track of rack teeth along an edge side for engaging the step-up gear or the plurality of step-up gears present. While the track of rack teeth can extend a relevant length of the lock-plate, it need only be long enough to engage a respective step-up gear to control a certain rotation thereof and thereby control the distance of movement (throw) of an assoiated pawl. Where two pawls are present in the latch, the lock-plate has two track teeth sections, sized and positioned to engage and operate a respective step-up gear.

The operator end of the lock-plate includes a paddle cam structure which is implemented by the interaction of a track of teeth in a flat face of the lock-plate bar adjacent the end thereof and a separately mounted, rotatable paddle cam. When the paddle cam plate is rotated by the operation of button being pushed, the paddle cam plate engages the lock-plate's flat face rack and as it is rotated further pulls the lock plate across the latch housing and against the spring pressure.

As the lock-plate moves, the teeth on the lock-plate mesh with the teeth of the step-up gears, which in turn mesh with the teeth on the drop pawls. Thus, when the activator button is pushed, and the paddle cam moves the lock-plate and step-up gears, and the two pawls are retracted into the housing in unison. This releases the latch from the striker wires or keepers to which it was engaged. When the activator button is released, the torsion spring slides the lock-plate back to its in-board position, and the latch returns to its original position with the pawls in their fully projected position out of the housing.

The lock-plate slide teeth engage the small pinion gear of each step up gear, while the larger pinion gear of the step-up gear engages the slide teeth of its associated pawl.

To close the latch, the striker wires push against the pawls which have a sloped or ramped end. This camming action pushes the pawls down into the housing against the spring pressure of the biasing torsion spring acting through the lock-plate and step-up gears. Once both strikers have passed the pawls, or the pawls have passed the strikers, the drop pawls will spring back into the holding position wherein the striker wires, i.e., keepers are engaged and the latch is in the closed position.

The latch can be mounted to a compartment door with the keepers/striker wires mounted to the compartment wall. Or, the latch can be mounted to the compartment wall with the striker wires mounted to the compartment door. The latch will operate equally well in either mounting.

Moreover, the shape of the housing, the shape of the sliding lock-plate, and the size and shape of the pawls can be modified to accommodate the shape and spacing of a particular glove box. The operator button will project on the outside of the compartment door or on the outside of the compartment wall to which the housing is mounted, for operation by an operator.

The sizing and strength of the components can be adjusted for the particular use of the invention.

### BRIEF DESCRIPTION OF THE DRAWINGS

The features, advantage and operation of the present invention will become readily apparent and further understood from a reading of the following detailed description with the accompanying drawings, in which like numerals refer to like elements, and in which:

FIG. 1 is a perspective view of the latch assembly of the present invention, in the latched position, showing the top of the latch housing;

FIG. 2 is the same perspective view of the latch assembly of FIG. 1, in the unlatched position;

FIG. 3 is a perspective view of the latch assembly of FIG. 1, showing the bottom of the latch housing;

FIG. 4 is a left side, closed end view of the latch assembly of FIG. 1;

FIG. 5 is a right side, paddle pawl end view of the latch assembly of FIG. 1;

FIG. 6 is a back face view of the latch assembly of FIG. 1, taken as shown in FIG. 1;

FIG. 7 is a front face view of the latch assembly of FIG. 1, taken as shown in FIG. 1;

FIG. 8 is a bottom face view of the latch assembly of FIG. 7;

FIG. 9 is a top face view of the latch assembly of FIG. 8;

FIG. 10 is a perspective view of the housing for the latch assembly, taken with the perspective of FIG. 1;

FIG. 11 is a perspective view showing the lock-plate, step-up gears, and pawl bolts of the latch assembly, in the latched position, taken with the perspective of FIG. 1;

FIG. 12 is a perspective view showing the lock-plate, step-up gears, and pawl bolts of the latch assembly, in the unlatched position, taken with the perspective of FIG. 1;

FIG. 13 is a perspective view of the lock-plate of FIG. 11 showing its top edge;

FIG. 14 is a perspective view of the lock-plate of FIG. 11 showing its bottom edge;

FIG. 15 is a top view of the lock-plate of FIG. 13;

FIG. 16 is a front face view of the lock-plate of FIG. 13;

FIG. 17 is a perspective view of a step-up gear, taken with the perspective of FIG. 1;

FIG. 18, is a side view of the step-up gear of FIG. 17;

FIG. 19 is a back face view of the step-up gear showing the back face of the larger pinion gear;

FIG. 20 is a front view of the step-up gear showing the front face of the smaller pinion gear and the larger pinion gear there behind;

FIG. 21 is a perspective view of a rectangular bolt, drop pawl, taken with the perspective of FIG. 1;

FIG. 22 is a back face view of the drop pawl of FIG. 22 showing the ramped surface;

FIG. 23 is a front face view of the drop pawl of FIG. 22 showing the track of rack teeth thereon;

FIG. 24 is a left side face view of the drop pawl of FIG. 22;

FIG. 25 shows step 1 in the assembling of the latch;

FIG. 26 shows step 2 in the assembling of the latch;

FIG. 27 shows step 3 in the assembling of the latch;

FIG. 28 shows step 4 in the assembling of the latch;

FIG. 29 shows step 5 in the assembling of the latch; and

FIG. 30 shows step 6 in the assembling of the latch.

### DETAILED DESCRIPTION OF THE INVENTION

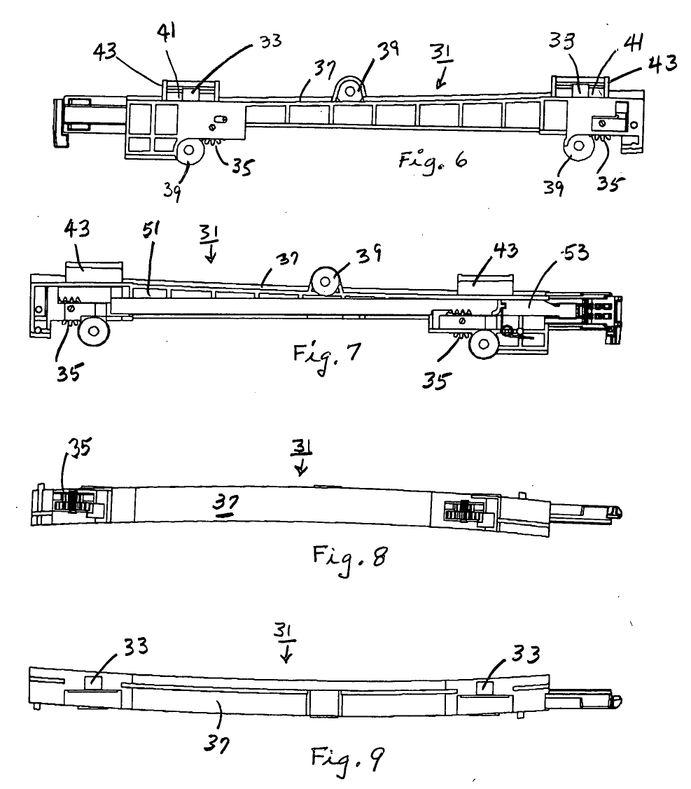

The present invention is a glove box latch assembly which utilizes gears to change movement direction, and to define the length of movement and the movement ratio between latch components. The latch assembly 31 is housed in an elongate housing 37, FIGS. 1-9, which is shaped to fit a glove box (not shown) to which it is mounted. In this regard, the size of the latch 31, the positioning of its pawls 33 and the positioning of its transfer, step-up gears 35 will vary with the specific glove box with which the latch 31 is to operate.

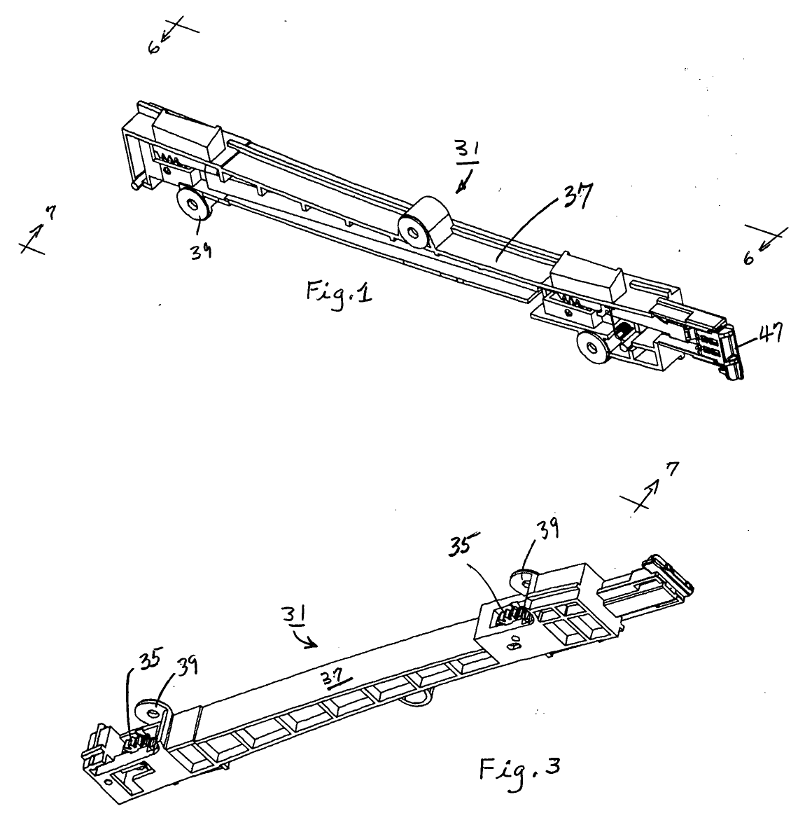

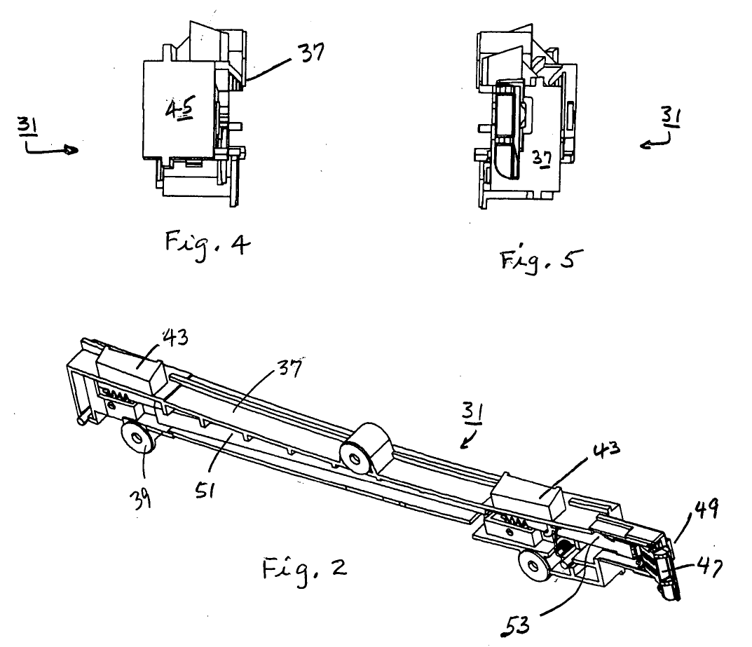

FIG. 1 is a perspective view of the latch assembly 31 of the present invention, in the latched position, showing the top of the latch housing 35, while FIG. 2 is the same perspective view of the latch assembly 31 of FIG. 1, in the unlatched position, and FIG. 3 is a perspective view of the latch assembly of FIG. 1, showing the bottom of the latch housing 35. FIGS. 4-9 are left-side view, right side view, back face view, front face view, bottom face view, and top face view, respectively of the latch assembly 31. As seen from FIG. 8, the front face and back face of the housing 31 is curved to match with a particular glove box door panel. Regardless of the outside configuration or curvature, the inside of the latch housing remains the same.

The housing 37 carries a plurality of mounting collets 39 for mounting the latch 31 to a door panel or compartment wall, as may be the case.

The latch 31 shown is a dual point, drop pawl latch. Two identical pawls 33 are mounted in the housing 37 in sockets 41, with one socket 41 and its drop pawl 33 positioned near one end of the housing 37 and the other socket 41 and its drop pawl 33 positioned near the opposite end of the housing 37. The sockets 41 each extend upwardly and open onto the top face of the housing 37, and are each surrounded by a guide enclosure 43. The enclosures 43 constrain striker wires (not shown) which are used as keepers for the drop pawls 33. The pawls 33 are rectangular-shaped bolts 33 which slide up and down in their respective housing slot 41 to exit the housing 37 on its top face.

Two step-up gears 35 are mounted in the housing 37, one adjacent a respective one of the drop pawls 33. These gears 35 engage the pawls 33 to control their position.

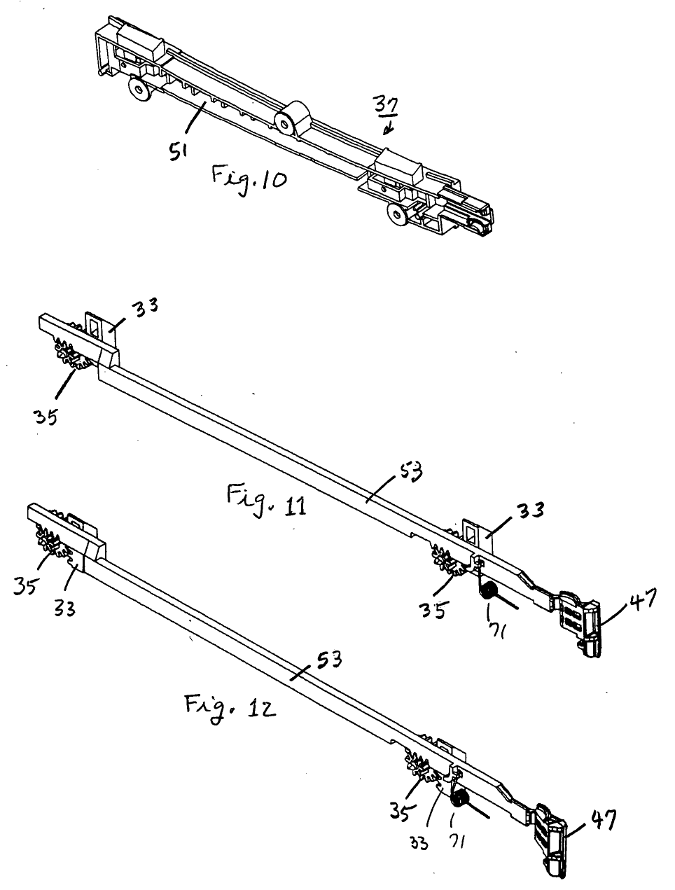

One end of the housing 37, shown at the left in FIGS. 1-3 has a closed-off wall 45. At the opposite end of the housing 37, a paddle cam 47 is mounted for rotation. This paddle cam 47 is shown in its non-rotated position in FIGS. 1, 3 and 11, and is shown in its rotated position in FIGS. 2 and 12. The paddle cam 47 can be operated by a button 49, FIG. 2.

Positioned within a channel 51, FIGS. 2 and 10, which extends longitudinally through the housing 37 is an elongate flat bar shaped lock-plate 53. This lock-plate 53 slides within the channel 51 and is engaged by the paddle cam 47 so that it is pulled slightly out of the housing 37 (to the right in FIGS. 1, 2, 11, 12) as the paddle cam 47 rotates.

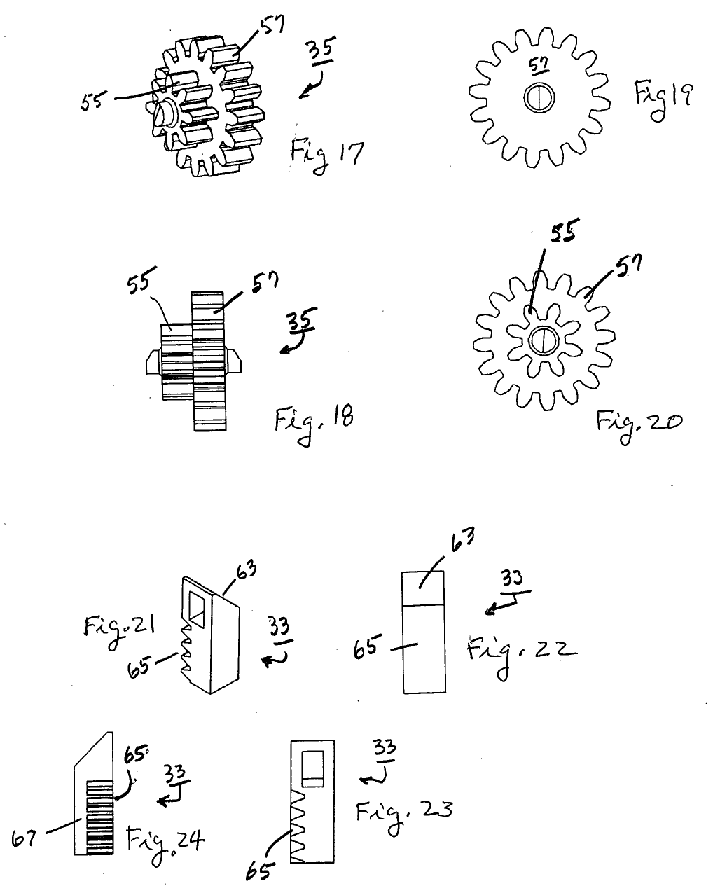

The interconnection of the bar-shaped lock-plate 53, the two drop pawls 33, and the two step-up gears 35 is easily understood from FIGS. 11 and 12. The step up gears 35 which are also shown in FIGS. 17-20 have a smaller pinion gear 53 adjacent a larger pinion gear 57 with both gears being concentric on the rotational axis of the step-up gear 33.

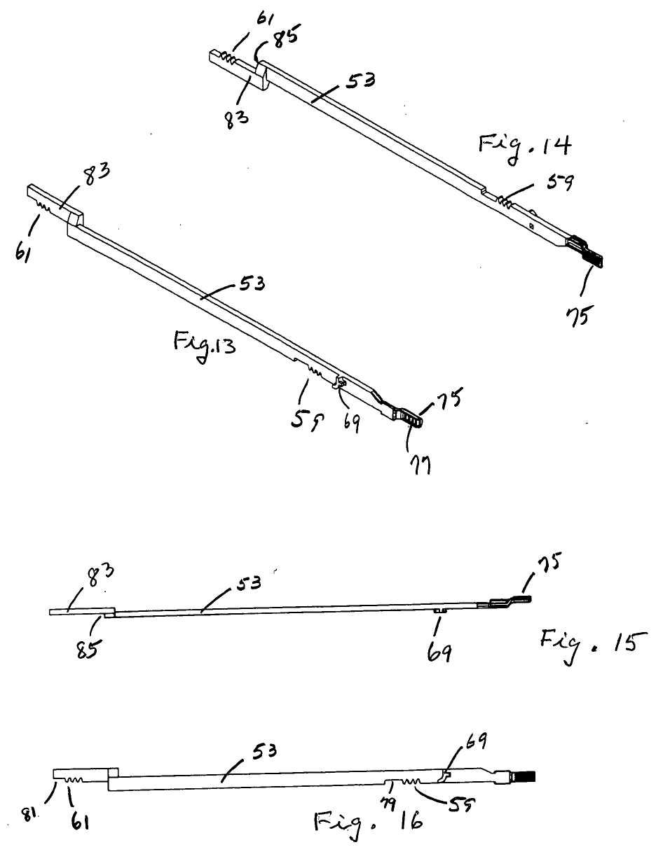

The bar-shaped lock-plate has a first and second tracks of teeth 59, 61, FIGS. 11, 12, 13-16 extending along the bottom edge side. These sliding track teeth 59, 61 are positioned to engage the small pinion gear 55 of the step-up gears 35, one each, respectively.

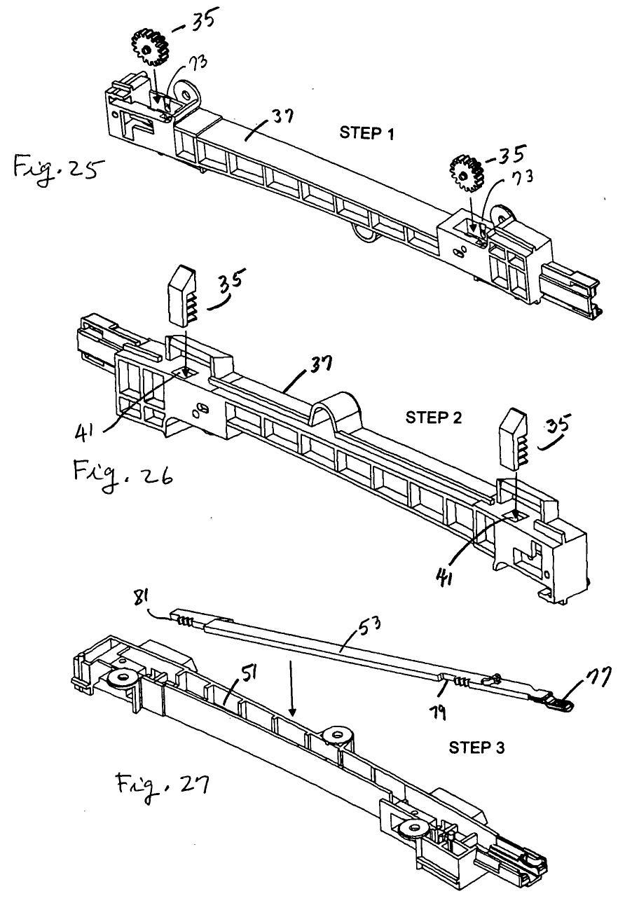

The housing sockets 41 in which the drop pawls 33 slide are rectangular in cross-section. The drop-pawls 33 are each rectangular cross-sectioned bolts, FIGS. 11, 12, 21-24. These pawl bolts 33 have a ramped outer end striker tongue 63 and a rectangular body 65 which has a track of rack teeth extending longitudinally along one wall of the body portion 65 of each pawl bolt 33. The teeth 65 do no extend completely across the side into which they are cut. This leaves a shoulder 67 for abutting the back face of the large pinion gear. This assists in maintaining of the position the pawl bolt 33 in its socket 41 and in constant positive contact with the step-up gear 35.

A torsion spring abutment shoulder 69 is positioned at the paddle cam 47 end of the lock-plate bar 53, on one flat face and between the position of the right drop pawl 33 and the paddle cam 47 end of the lock-plate bar. A torsion spring 71 is positioned in the housing 37 with one leg against the spring abutment shoulder 69 on the lock-plate 53. This spring 71 biases the lock plate 53 to the left in FIGS. 1, 2, and 11. This left position is the latch position for the lock and is shown is FIGS. 1 and 11. The right position is shown in FIGS. 2 and 12 where the lock-plate 53 is pulled to the right by the paddle cam 47.

In the latched position, FIGS. 1 and 11, the spring 71 has slid the lock-plate 53 to the left, which sliding motion has caused the lock-plate first and second tracks of teeth to rotate their respective small pinion gears 55. As the small pinion gears 55 are a part of the step-up gear 35 structure, their rotation rotates the larger pinion gears 57 which are in engagement with the track teeth 65 on the pawl bolts 33. In the latched position, FIG. 11, the pawl bolts 33 are in the fully upward extended position.

When the paddle cam 47 is rotated to pull the lock-plate to the right, FIGS. 2 and 12, the operation is reversed, and the pawl bolts 33 are pulled down to their fully retracted position.

The paddle cam end of the lock-plate 53 has a flat tongue 75 extending there from. Formed in the flat face on one side of this tongue 75 is a series of track teeth 77, FIGS. 13, 16, 27 and 28. The paddle cam 47 engages one of these track teeth 77 to pull the lock-plate to the right and to slide it out of the housing a short distance.

For purposes of assembly, the lock-plate has two cutout sections 79, 81, FIGS. 13-16, one adjacent each inboard side of each track tooth section 59, 61. The inboard track tooth section 61 is on an off-set leg 83 of the lock-plate bar 53. This establishes a small shoulder 85 against which the inboard rectangular pawl bolt 33 rides.

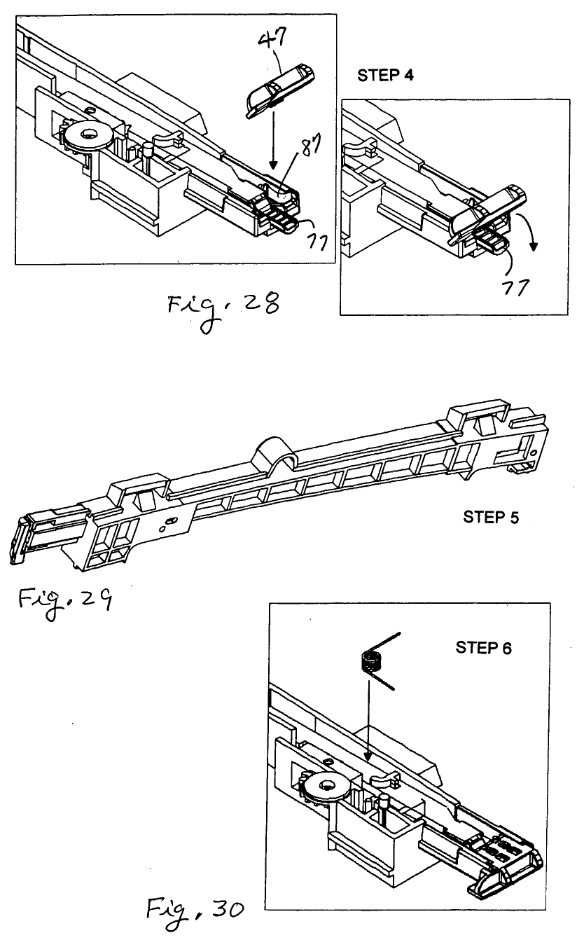

The latch assembly 31 is capable of being assembled prior to mounting in a number of easy steps, with little or no specific tools. In STEP 1, FIG. 25, the gears 35 are pushed into receiving slots 73 in the housing 37 until they snap into position. In STEP 2, FIG. 26, the rectangular bolt pawls 35 are pushed into their sockets 41 as far as possible to assure that the teeth on the pawls mesh with the teeth on the step-up gears. In STEP 3, FIG. 27, the lock-plate is inserted into the housing through the open wall thereof and into the channel 51. The inboard tip adjacent the inboard cutout 81. The cutouts align with the gear teeth during this portion of the assembly. In STEP 4 FIG. 28, the lock-plate is slid across to the right and the paddle cam is snapped into receiving sockets in the housing. In STEP 5, FIG. 29, the gear teeth and track teeth are checked to see if properly meshed and proper tooth engagement for proper pawl movement. In STEP 6, the torsion spring is inserted into the housing and the spring leg is seated correctly to the lock-plate.

Many changes can be made in the above-described invention without departing from the intent and scope thereof. It is therefore intended that the above description be read in the illustrative sense and not in the limiting sense. Substitutions and changes can be made while still being within the scope and intent of the invention and of the appended claims.

What is claimed is:

1. A latch, comprising:
a housing;
a lock-plate slidably operative within said housing;
a gear positioned for rotation within said housing;
a pawl carrying teeth, said pawl being slidably positioned within said housing for movement beyond a wall of said housing; and
an activator for moving said lock-plate in a sliding motion;
wherein said lock-plate carries a track of teeth which engage said the teeth of said gear; and
wherein said pawl teeth engage the teeth of said gear.

2. The latch of claim 1, wherein said gear is a step-up gear having a smaller pinion gear and a larger pinion gear.

3. The latch of claim 2, wherein pawl teeth are a track of teeth engaging the larger pinion gear of said step-up gear.

4. The latch of claim 3, wherein said lock-plate track of teeth engage the smaller pinion gear of said step-up gear.

5. The latch of claim 4, wherein said lock-plate is an elongate flat bar, and wherein said lock-plate track of teeth are positioned on an edge side thereof.

6. The latch of claim 5, wherein said housing has a first slot, wherein said pawl is a slide bolt positioned within said housing first slot, and wherein said pawl track of teeth extend longitudinally along said bolt.

7. The latch of claim 6, wherein said lock-plate elongate flat bar carries a second track of teeth on the flat face thereof adjacent said activator, and wherein said activator includes a paddle cam pivotally mounted onto said housing, wherein said paddle cam engages said lock-plate elongate flat bar second track of teeth as it is rotated to slide said lock-plate within said housing.

8. The latch of claim 7, wherein said paddle cam movement slidably moves said lock-plate elongate bar which movement rotates said step-up gear which movement retracts said pawl bolt, and said latch also including an activator button mounted adjacent said paddle cam, wherein when said button is operated, said paddle cam is rotated, and said latch also including a biasing spring connected between said housing and said lock-plate elongate bar, said spring biasing said lock-plate elongate bar to a first position wherein said pawl bolt is in its fully extended position.

9. The latch of claim 8, also including a second said step-up gear rotatably mounted in said housing, wherein said housing includes a second said slot, wherein said latch includes a second said track toothed pawl bolt slidably positioned within said housing second slot; wherein said second pawl bolt teeth engage the large pinion gear of said second step-up gear, and wherein said lock-plate elongate flat bar includes a third track of teeth on the same edge side as the first track of teeth, said third track of teeth engaging the small pinion gear of said second pawl bolt teeth, wherein said first and second pawl bolts move in unison as said lock-plate elongate flat bar is moved.

10. A latch, comprising:
an elongate housing;
a pawl positioned within said housing for movement in and out of a wall thereof;
an actuator connected to said housing at a location disparate from said pawl;
a lock-plate operative within said housing for actuating said pawl upon the actuation of said actuator; and
connection means for driving said pawl upon a movement of said lock-plate, said connection means including a step-up gear for transferring motion from said lock-plate to said pawl.

11. The latch of claim 10, wherein said drop pawl is biased to a vertical extended position.

12. The latch of claim 11, wherein said lock-plate has an elongate flat bar shape and is mounted for sliding movement within said housing.

13. The latch of claim 12, wherein said drop pawl is a slide bolt, wherein said step-up gear has a smaller gear and a larger gear, and wherein said step-up gear is mounted for rotation within said housing in a plane extending parallel to a sliding axis of said slide bolt.

14. The latch of claim 13, wherein said motion transfer structure includes a rack of teeth extending along said bar-shaped lock-plate and a rack of teeth extending along said slide bolt, wherein said lock-plate teeth engage one gear on said step-up gear and said slide bolt teeth engage the other gear on said step-up gear.

15. A latch, comprising:
a housing;
a drop pawl positioned within said housing for movement in and out of said housing;
an actuator connected to said housing;
a lock-plate operative within said housing for actuating said pawl upon the actuation of said actuator; and
motion transfer structure for driving said drop pawl upon a movement of said lock-plate, said motion transfer structure including a step-up gear for transferring motion from said lock-plate to said pawl.

16. The latch of claim 15, also including a plurality of teeth connected to said drop pawl, and a plurality of teeth connected to said lock-plate, wherein said step-up gear has a plurality of different pinion gears, wherein said drop pawl teeth engage the teeth of one of the pinion gears on said step-up gear and the lock-plate teeth engage the teeth of another of the pinion gears on said step-up gear.

17. The latch of claim 16, also including a spring, said spring biasing said lock-plate to a first position wherein said drop pawl is at a fully extended position out of said housing.

18. The latch of claim 17, wherein said actuator includes a paddle cam mounted for rotation in said housing, wherein said lock-plate has at least on protrusion adjacent said paddle cam mounting, and wherein said paddle cam engages said lock-plate protrusion as it is rotated.

19. The latch of claim 18, wherein said housing includes a socket, and wherein said drop pawl is mounted for sliding motion within said socket.

20. The latch of claim 19, wherein said drop pawl has a rectangular bolt shape, wherein said plurality of drop pawl teeth extend as a rack along said bolt, wherein said lock-plate is bar-shaped, wherein said plurality of lock-plate teeth form a rack of teeth extending along said bar-shaped lock-plate, wherein said bar-shaped lock-plate includes a second rack of teeth positioned adjacent said paddle cam mounting, and wherein said paddle cam engages said second rack of teeth as it is rotated.
